(19) United States
(12) Patent Application Publication
(10) Pub. No.: US 2013/0167669 A1
(43) Pub. Date: Jul. 4, 2013

(54) PHYSICAL QUANTITY DETECTOR AND ELECTRONIC APPARATUS

(71) Applicants: Jun WATANABE, Matsumoto-shi (JP); Kazuyuki NAKASENDO, Shiojihi-shi (JP); Takahiro KAMETA, Okaya-shi (JP)

(72) Inventors: Jun WATANABE, Matsumoto-shi (JP); Kazuyuki NAKASENDO, Shiojihi-shi (JP); Takahiro KAMETA, Okaya-shi (JP)

(73) Assignee: SEIKO EPSON CORPORATION, Tokyo (JP)

(21) Appl. No.: 13/597,678

(22) Filed: Aug. 29, 2012

(30) Foreign Application Priority Data
Aug. 30, 2011 (JP) 2011-186959

(51) Int. Cl. B06B 1/06

(52) U.S. Cl. CPC B06B 1/06
USPC 73/865

(57) ABSTRACT

An acceleration detector includes: a plate-like flexible portion which has piezoelectricity and can flex by an inertial force (base portion, joint portion, moving portion); an acceleration detection element loaded on a main surface of the base portion and the moving portion; an electrically conductive mass portion loaded on the moving portion; and a package accommodating the base portion, the joint portion, the moving portion, the acceleration detection element and the mass portion. The acceleration detection element is provided with wirings through which detected acceleration is taken out as an electrical signal, and the mass portion can be maintained at a desired electric potential.

### BACKGROUND

1. Technical Field

The present invention relates to a physical quantity detector and an electronic apparatus having this physical quantity detector.

2. Related Art

As a physical quantity detector, JP-A-2-248866 discloses an acceleration sensor structured in such a way that, on both sides or one side of a beam that is made of a quartz crystal plate with one end thereof fixed to a base and with a weight arranged on the other end, a double-ended tuning fork-type vibrator having the same cut angle as the beam is fixed. In the acceleration sensor, a pair of protrusions for fixing and supporting both ends of the double-ended tuning fork-type vibrator is provided with a predetermined spacing at least on one side of the beam and the double-ended tuning fork-type vibrator is fixed in a bridge-like manner between the protrusions.

The acceleration sensor of JP-A-2-248866 has an advantage that excellent acceleration detection sensitivity is achieved with the mass effect of the weight. Also, in this acceleration sensor, the beam and the double-ended tuning fork-type vibrator are made of the same material and therefore have the same coefficient of thermal expansion. Thus, stress strain (thermal stress) generated in a bonding part between the two components because of temperature change can be reduced.

However, in the acceleration sensor of JP-A-2-248866, for example, in order to reduce the size when housing the acceleration sensor in a package, the metallic weight and a metallic lid (cover) of the package are arranged closely to each other and therefore electrostatic capacitance may occur between the weight and the lid.

This electrostatic capacitance increases and decreases, linked with a change in a distance (d) between the weight and the lid (counter-electrode) due to flexure of the beam when acceleration is applied as a physical quantity, according to an equation (1), which is a general expression of electrostatic capacitance:

C=ε×S/d (1)

where C is electrostatic capacitance, S is the area of the counter-electrode, d is the distance from the counter-electrode, and ε is permittivity.

In the acceleration sensor, since the weight and the double-ended tuning fork-type vibrator are arranged closely to each other in order to reduce the size, the coupling of the weight and the double-ended tuning fork-type vibrator may add the above increasing or decreasing electrostatic capacitance to an oscillation circuit of the double-ended tuning fork-type vibrator and the vibration of the double-ended tuning fork-type vibrator may become unstable.

Consequently, acceleration detection properties such as acceleration detection accuracy of the acceleration sensor may deteriorate.

Also, in the acceleration sensor, a quartz crystal plate, which is a piezoelectric material, is used for the beam. Therefore, when acceleration is applied, an electric charge (electromotive force) due to the piezoelectric effect tends to be generated in the bonding part between the beam and the weight where an inertial force concentrates.

In the acceleration sensor, the generated electric charge becomes static electricity with different polarities on a face side (lid side) of the beam and on a back side of the beam (package inner bottom surface (inside bottom surface) side) because of polarization. Thus, an electrostatic force occurs between the face side of the beam and the lid of the package, or between the back side of the beam and the wiring on the inner bottom surface side of the package or the like.

In the acceleration sensor, the beam is attracted toward the lid of the package or attracted toward the inner bottom surface side of the package due to the electrostatic force, and the original flexure of the beam is obstructed. Therefore, acceleration detection properties such as acceleration detection sensitivity may deteriorate.

Also, in the acceleration sensor, since the electric potential of the weight itself is unstable, electrical disturbance may affect the weight and therefore the coupling state may change via parasitic capacitance between the weight and the double-ended tuning fork-type vibrator, thus adversely affecting acceleration detection properties.

### SUMMARY

An advantage of some aspects of the invention is to solve at least a part of the problems described above, and the invention can be implemented as the following forms or application examples.

### Application Example 1

According to this application example, a physical quantity detector includes a plate-like flexible portion having piezoelectricity, a physical quantity detection element loaded at least on one of two main surfaces of the flexible portion, an electrically conductive mass portion loaded on the flexible portion, and a package accommodating the flexible portion, the physical quantity detection element and the mass portion. The physical quantity detection element is provided with a wiring through which a detected physical quantity is taken out as an electrical signal. The mass portion can be maintained at a desired electric potential.

According to this application example, in the physical quantity detector, the physical quantity detection element (equivalent to a double-ended tuning fork-type vibrator) is provided with the wiring through which a detected physical quantity is taken out as an electrical signal, and the mass portion (equivalent to a weight) loaded in the flexible portion (equivalent to a beam) can be maintained at a desired electric potential.

Consequently, in the physical quantity detector, the mass portion and a part of the package, for example, a cover, have the same electric potential and therefore electrostatic capacitance between the mass portion and the lid is eliminated. Thus, coupling between the mass portion and the physical quantity detection element can be avoided and the behavior of the physical quantity detection element can be stabilized.

Therefore, physical quantity detection properties such as physical quantity detection accuracy of the physical quantity detector can be improved.

### Application Example 2

In the physical quantity detector according to the above application example, it is preferable that the package includes a package base in which the flexible portion, the physical quantity detection element and the mass portion are loaded, and an electrically conductive cover which is loaded on the package base and covers the physical quantity detection element, and that the mass portion can be maintained at the same electric potential as the cover.

According to this application example, in the physical quantity detector, the package includes the package base in which each component is loaded and the electrically conductive cover which covers the package base, and the mass portion can be maintained at the same electric potential as the cover. Therefore, electrostatic capacitance between the mass portion and the cover can be eliminated.

Consequently, in the physical quantity detector, coupling between the mass portion and the physical quantity detection element can be avoided and the behavior of the physical quantity detection element can be stabilized.

Therefore, physical quantity detection properties such as physical quantity detection accuracy of the physical quantity detector can be improved.

### Application Example 3

In the physical quantity detector according to the above application example, it is preferable that, in the package base, an electrically conductive portion is provided on an inner bottom surface that is opposite to the cover, that the flexible portion has an electrode provided extending to the two main surfaces, and that the mass portion is electrically connected to the electrode and can be maintained at the same electric potential as the electrically conductive portion.

According to this application example, in the physical quantity detector, the electrically conductive portion is provided on the inner bottom surface of the package, and the mass portion is connected to the electrode of the flexible portion and can be maintained at the same electric potential as the electrically conductive portion.

Thus, in the physical quantity detector, generation of an electric charge with different polarities on the two main surfaces due to a piezoelectric effect in a bonding part between the flexible portion and the mass portion is restrained. The mass portion and the electrode of the flexible portion, and the electrically conductive portion on the inner bottom surface of the package base and the cover have the same electric potential.

Consequently, in the physical quantity detector, since an electrostatic force between the flexible portion, and the inner bottom surface of the package base and the cover, can be mostly resolved and therefore obstruction of the flexure of the flexible portion by the electrostatic force can be restrained.

Therefore, physical quantity detection properties such as physical quantity detection sensitivity of the physical quantity detector can be improved.

### Application Example 4

In the physical quantity detector according to the above application example, it is preferable that the mass portion has a cut-out part and is loaded on the main surface of the flexible portion where the physical quantity detection element is loaded, and that a part of the physical quantity detection element is arranged within the cut-out part of the mass portion, as viewed in a plan view.

According to this application example, in the physical quantity detector, the mass portion is loaded on the main surface of the flexible portion where the physical quantity detection element is loaded, and apart of the physical quantity detection element is arranged within the cut-out part of the mass portion, as viewed in a plan view.

Consequently, in the physical quantity detector, the space of the flexible portion can be efficiently utilized and further reduction in size can be realized, while physical quantity detection properties can be improved by effects and advantages similar to the above application examples.

### Application Example 5

In the physical quantity detector according to the above application example, it is preferable that the flexible portion has a base portion and a moving portion connected to the base portion via a joint part, that the moving portion can be displaced in a direction that intersects a main surface of the moving portion, about the joint part as a fulcrum, that the physical quantity detection element is laid across the joint part to the base portion and the moving portion, and that the mass portion is loaded on the main surface of the moving portion.

According to this application example, in the physical quantity detector, the flexible portion has the base portion, the joint part and the moving portion. The moving portion can be displaced in the direction of intersecting the main surface, on the joint part as a fulcrum. The physical quantity detection element is laid cover the joint part to the base portion and the moving portion. The mass portion is loaded on the main surface of the moving portion.

Consequently, in the physical quantity detector, since the flexible portion is configured to flex more easily, detection sensitivity, in particular, of physical quantity detection properties can be improved further.

### Application Example 6

According to this application example, an electronic apparatus includes the physical quantity detector according to one of the above application examples.

According to this application example, since the electronic apparatus of this configuration has the physical quantity detector according to one of the above application examples, an electronic apparatus that has advantages of one of the above application examples can be provided.

### BRIEF DESCRIPTION OF THE DRAWINGS

The invention will be described with reference to the accompanying drawings, wherein like numbers reference like element.

FIG. 1 is a partially exploded schematic perspective view showing a schematic configuration of an acceleration detector according to a first embodiment.

FIGS. 2A and 2B are schematic plan and sectional views showing a schematic configuration of the acceleration detector of FIG. 1. FIG. 2A is a plan view. FIG. 2B is a sectional view taken along A-A in FIG. 2A.

FIGS. 3A and 3B are schematic sectional views illustrating operation of the acceleration detector. FIG. 3A is a sectional view showing the state where a moving portion is displaced downward in the drawing (−Z direction). FIG. 3B is a sectional view showing the state where the moving portion is displaced upward in the drawing (+Z direction).

FIGS. 4A and 4B are circuit diagrams of an oscillation circuit including an acceleration detection element. FIG. 4A is a circuit diagram in the case where a mass portion and a lid do not have the same electric potential. FIG. 4B is a circuit diagram in the case where the mass portion and the lid have the same electric potential.

FIG. 5 is a schematic perspective view showing a clinometer according to a second embodiment.

FIG. 6 is a partially exploded schematic perspective view showing a schematic configuration of an inclination sensor module accommodated within the clinometer.

### DESCRIPTION OF EXEMPLARY EMBODIMENTS

Hereinafter, specific embodiments of the invention will be described with reference to the drawings.

### First Embodiment

First, an example of configuration of a physical quantity detector will be described.

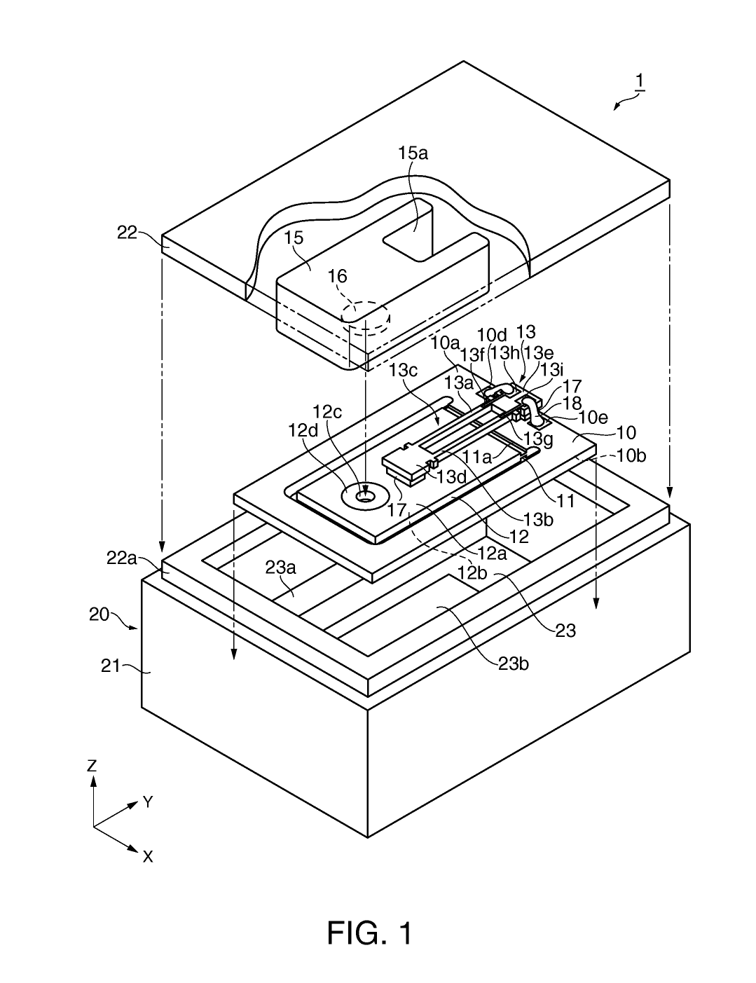

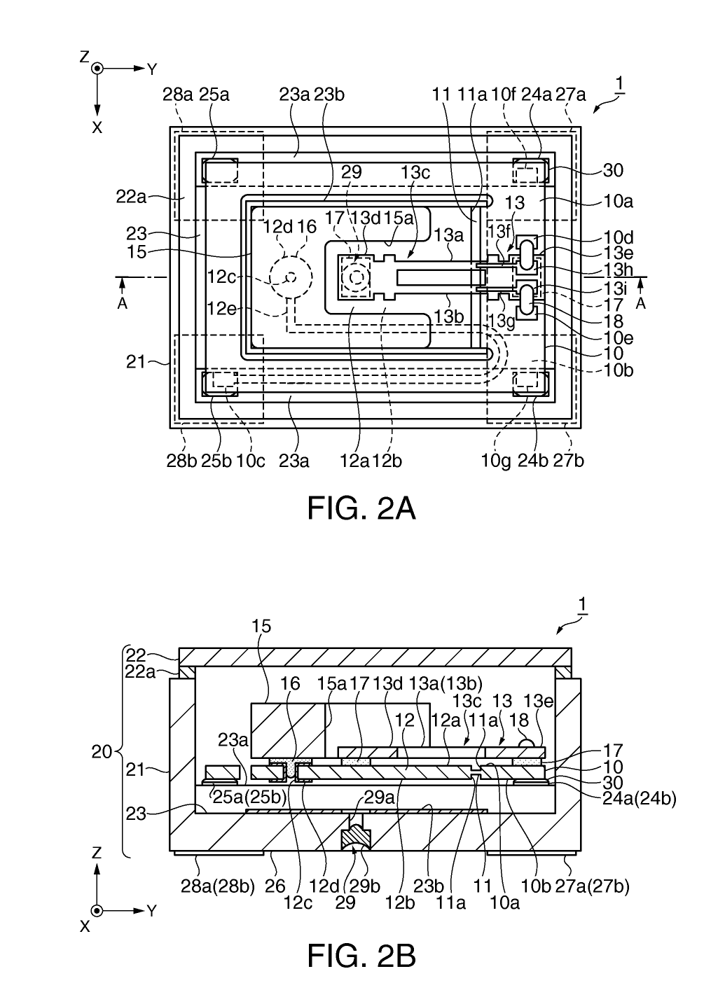

FIG. 1 is a partially exploded schematic perspective view showing a schematic configuration of an acceleration detector as an example of a physical quantity detector according to a first embodiment. FIGS. 2A and 2B are schematic plan and sectional views showing a schematic configuration of the acceleration detector of FIG. 1. FIG. 2A is a plan view.

FIG. 2B is a sectional taken along A-A in FIG. 2A. The illustration of part of the wirings is omitted. In FIG. 2A, the illustration of a lid (cover) is omitted. The dimensional proportion of each component is different from reality.

As shown in FIG. 1 and FIGS. 2A and 2B, an acceleration detector 1 includes a flat frame-like base portion 10, a rectangular flat plate-like moving portion 12 which is arranged on the inner side of the frame of the base portion 10 and has one end (fixed end) connected to the base portion 10 via a joint part 11, an acceleration detection element 13 as a physical quantity detection element laid over the joint part 11 to the base portion 10 and the moving portion 12, and a package 20 accommodating each of the components.

In the acceleration detector 1, a part of the base portion 10 that is near the joint part 11 and where one side of the acceleration detection element 13 is fixed, the joint part 11 and the moving portion 12 are equivalent to a flexible portion.

The base portion 10, the joint part 11 and the moving portion 12 are integrally formed in a substantially flat plate-like shape, using a quartz crystal substrate that is sliced out at a predetermined angle from, for example, a quartz crystal ore with piezoelectricity or the like. Between the moving portion 12 and the base portion 10, except the one end side connected via the joint part 11, a slit-like through-hole that separates the moving portion 12 and the base portion 10 is provided.

The outer shape of the base portion 10, the joint part 11 and the moving portion 12 is accurately formed using a technique such as photolithography or etching.

In the moving portion 12, an electrode 12d is provided in such a way as to extend via a through-hole 12c to two main surfaces 12a, 12b equivalent to face and back sides of the flat plate. A wiring 21e led out from the side of the main surface 12b of the electrode 12d is connected to an external connection terminal 10c provided on the side of a main surface 10b of two main surfaces 10a, 10b of the base portion 10, at a bottom left corner part in FIG. 2A (the corner part in +X direction and −Y direction), via the joint part 11.

Also, an electrically conductive mass portion 15 as an inertial mass portion is loaded on the main surface 12a of the moving portion 12. The mass portion 15 is bonded to the electrode 12d on the main surface 12a via an electrically conductive bonding member 16. Thus, the mass portion 15 is electrically connected with the electrode 12d.

In the joint part 11, a closed-bottom groove part 11a is formed by half etching from the sides of the two main surfaces 12a, 12b (10a, 10b), along a direction (X-axis direction) orthogonal to a direction connecting the base portion 10 and the moving portion 12 (Y-axis direction) in such a way as to separate the base portion 10 and the moving portion 12.

With the groove part 11a, the cross section of the joint part 11 along Y-axis direction (the shape shown in FIG. 2B) is substantially in an H-shape.

This joint part 11 enables the moving portion 12 to be displaced (rotated) in a direction that intersects the main surface 12a about the joint part 11 as a fulcrum (rotation axis) according to the acceleration applied in a perpendicular direction (Z-axis direction) intersecting the main surface 12a (12b) (and the accompanying inertial force and gravity). In other words, the moving portion 12 as the flexible portion can flex by an inertial force.

The mass portion 15 extends from a free end side of the moving portion 12 that is opposite to the side of the joint part 11 up to the vicinity of the joint part 11, in a bifurcated form avoiding the acceleration detection element 13, and is thus formed in a substantially U-shape as viewed in a plan view, in order to maximize the planar size (volume and mass) and thus improve the sensitivity of the acceleration detector 1.

That is, the mass portion 15 has a substantially U-shaped cut-out part 15a penetrating the mass portion 15 in the direction of thickness (Z-axis direction). A part of the acceleration detection element 13 is consequently arranged inside the cut-out part 15a, as viewed in a plan view.

For the mass portion 15, for example, a material with a relatively large specific gravity, typically a metal such as Cu (copper) or Au (gold), is used.

For the bonding member 16, for example, an electrically conductive adhesive having an electrically conductive material such as a metal filler mixed therein and containing a silicone resin with excellent elasticity (modified silicone resin or the like), a solder, an Au/Sn alloy or the like is used.

The bonding range between the mass portion 15 and the moving portion 12 (electrode 12d) may preferably secure a necessary area for the bond strength with the moving portion 12 but is smaller than the plane area of the mass portion 15 in view of restraint of thermal stress. Also, in view of avoiding inclination of the mass portion 15 at the time of bonding, the center of gravity of the mass portion 15 may preferably fall within the bonding range, as viewed in a plan view.

The acceleration detection element 13 includes an acceleration detection portion 13c having two rectangular pillar-like vibration beams 13a, 13b that extend in the direction connecting the base portion 10 and the moving portion 12 (Y-axis direction) and bend and vibrate in X-axis direction, a pair of basal parts 13d, 13e connected at both ends of the acceleration detection portion 13c, and wirings 13f, 13g (partly not shown) that are provided from the vibration beams 13a, 13b to the basal part 13e and take out the detected acceleration as a physical quantity, in the form of an electrical signal.

The acceleration detection element 13 is also called a double-ended tuning fork-type vibration element (double-ended tuning fork-type element, double-ended tuning fork-type vibrator) because the two vibration beams 13a, 13b and the pair of basal parts 13d, 13e form two sets of tuning forks using a piezoelectric material.

In the acceleration detection element 13, the acceleration detection portion 13c and the basal parts 13d, 13e are integrally formed substantially in a flat plate shape, for example, using a quartz crystal substrate sliced out at a predetermined angle from a quartz crystal ore. Also, the outer shape of the acceleration detection element 13 is accurately formed using a technique such as photolithography or etching.

The acceleration detection element 13 has one basal part 13d fixed on the side of the main surface 12a of the moving portion 12 via a bonding member 17, for example, a low-melting glass, Au/Sn alloy coating capable of eutectic bonding or the like, and has the other basal part 13e fixed on the side of a main surface 10a of the base portion 10 (the same side as the main surface 12a of the moving portion 12) via a bonding member 17.

A predetermined gap is provided between the acceleration detection element 13, and the main surface 10a of the base portion 10 and the main surface 12a of the moving portion 12, so that the acceleration detection element 13, and the base portion 10 and the moving portion 12 do not contact each other when the moving portion 12 is displaced. In this embodiment, this gap is managed by the thickness of the bonding member 17.

Specifically, the gap can be managed within a predetermined range, for example, by fixing the base portion 10 and the moving portion 12, and the acceleration detection element 13 to each other via the bonding member 17 in the state where a spacer formed to a thickness equivalent to the predetermined gap is inserted between the base portion 10 and the moving portion 12, and the acceleration detection element 13.

In the acceleration detection element 13, lead-out electrodes 13h, 13i led out to the basal part 13e from the wirings 13f, 13g (functioning as excitation electrodes) of the vibration beams 13a, 13b are connected to connection terminals 10d, 10e provided on the main surface 10a of the base portion 10, for example, by an electrically conductive adhesive (for example, silicone-based electrically conductive adhesive) 18 containing an electrically conductive material such as a metal filler.

More specifically, the lead-out electrode 13h is connected to the connection terminal 10d, and the lead-out electrode 13i is connected to the connection terminal 10e.

The connection terminals 10d, 10e on the base portion 10 are connected to external connection terminals 10f, 10g provided at two corner parts on the +Y direction side on the main surface 10b of the base portion 10 by a wiring, not shown. More specifically, the connection terminal 10d is connected to the external connection terminal 10f on the −X side direction, and the connection terminal 10e is connected to the external connection terminal 10g on the +X direction side.

The electrode 12d and the wiring 12e of the moving portion 12, the wirings 13f, 13g and the lead-out electrodes 13h, 13i of the acceleration detection element 13, and the connection terminals 10d, 10e and the external connection terminals 10c, 10f, 10g of the base portion 10 are configured, for example, with Cr as an underlying layer and Au stacked thereon.

The package 20 has a package base 21 with a substantially rectangular plane shape and having a recessed part, and a flat plate-like lid 22 as a cover with a substantially rectangular plane shape for covering the recessed part of the package base 21. The package 20 is thus formed in a substantially rectangular-parallelepiped shape.

For the package base 21, an aluminum oxide-based sintered body formed by molding, stacking and sintering ceramic green sheets, or quartz crystal, glass, silicon or the like is used.

For the lid 22, an electrically conductive metal such as Kovar, 42 alloy or stainless steel is used.

In the package base 21, internal terminals 24a, 24b, 25a, 25b are provided at two step parts 23a protruding to the opposite sides along inner walls of the recessed part from outer peripheral parts of an inner bottom surface (inside bottom surface of the recessed part) 23.

The internal terminals 24a, 24b, 25a, 25b are provided at both ends in a longitudinal direction of each step part 23a. Also, the internal terminals 24a, 24b, 25b are provided at positions facing the external connection terminals 10c, 10f, 10g of the base portion 10 (overlapping positions as viewed in a plan view). The internal terminal 25a is provided to keep the balance of the base portion 10 so that the base portion 10 is not inclined toward the internal terminal 25a when the base portion 10 is fixed to the package base 21.

On the inner bottom surface 23 of the package base 21, which is opposite to the lid 22, an electrically conductive portion 23b that is a metallic film is provided in a substantially rectangular shape at a position facing the moving portion 12.

On an outer bottom surface (surface opposite to the inner bottom surface 23, outside bottom surface) 26 of the package base 21, external terminals 27a, 27b, 28a, 28b used for mounting the package on an external member (for example, a printed circuit board) of an electronic apparatus or the like are formed.

The external terminals 27a, 27b, 28a, 28b are connected to the internal terminals 24a, 24b, 25a, 25b by internal wirings, not shown. For example, the external terminal 27a is connected to the internal terminal 24a. The external terminal 27b is connected to the internal terminal 24b. The external terminal 28a is connected to the internal terminal 25a. The external terminal 28b is connected to the internal terminal 25b and the electrically conductive portion 23b.

The external terminal 28a need not be connected to the internal terminal 25a if the external terminal 28a needs no electrical function and is used as a terminal for securing a fixing strength when the package is mounted on an external member.

The internal terminals 24a, 24b, 25a, 25b, the external terminals 27a, 27b, 28a, 28b and the electrically conductive portion 23b are made of a metallic film formed by stacking each coating of Ni, Au or the like by a method such as plating on a metalized layer of W, Mo or the like.

In the package base 21, a sealing portion 29 which seals the inside of the package 20 is provided in a bottom part of the recessed part.

The sealing portion 29 is configured to seal the inside of the package 20 airtightly, by putting a sealant 29b made of an Au/Ge alloy, solder or the like into a stepped through-hole 29a formed in the package base 21 and having a greater hole diameter on the side of the outer bottom surface 26 than on the side of the inner bottom surface 23, then heating and melting the sealant and subsequently hardening the sealant.

In the acceleration detector 1, the parts (four corner parts) including the external connection terminals 10c, 10f, 10g of the base portion 10 are fixed to the internal terminals 24a, 24b, 25a, 25b in the stepped parts 23a of the package base 21, for example, via an electrically conductive adhesive (for example, silicone-based electrically conductive adhesive) 30 containing an electrically conductive material such as a metal filler.

Thus, the external connection terminals 10c, 10f, 10g can realize electrical conduction (electrical connection) with the internal terminals 24a, 24b, 25a, 25b. To fix the base portion 10 with the internal terminal 25a, a non-conductive adhesive may be used since electrical connection is not required.

Here, the external connection terminal 10c, which is electrically connected with the mass portion 15 and the electrode 12d and the wiring 12e of the moving portion 12, is electrically connected to the electrically conductive part 23b and the external terminal 28b of the package base 21 via the internal terminal 25b.

In the acceleration detector 1, the recessed part of the package base 21 is covered by the lid 22 in the state where the base portion 10 is fixed to the internal terminals 24a, 24b, 25a, 25b of the package base 21, and the package base 21 and the lid 22 are bonded together by a bonding member 22a such as a seam ring, low-melting glass or adhesive.

At this time, the lid 22 is electrically connected to the external terminal 28b via an internal wiring, not shown.

In the acceleration detector 1, after the lid 22 is bonded, the sealant 29b is put into the through-hole 29a of the sealing portion 29 in the state where pressure inside the package 20 is reduced (a state with a high degree of vacuum). The sealant is heated and melted and subsequently hardened, thus sealing the inside of the package 20 airtightly.

The inside of the package 20 may be filled with an inert gas such as nitrogen, helium or argon.

The package may have a recessed part both in the package base and in the lid.

In the acceleration detector 1, a drive signal applied to the wirings 13f, 13g (excitation electrodes) of the acceleration detection element 13 via the external terminals 27a, 27b, the external connection terminals 10f, 10g and the like causes the vibration beams 13a, 13b of the acceleration detection element 13 to oscillate (resonate) at a predetermined frequency.

Then, in the acceleration detector 1, the resonance frequency of the acceleration detection element 13, which changes according to the acceleration applied, is outputted as an output signal (electrical signal).

In the acceleration detector 1, as the external terminal 28b is mounted on a ground (GND) terminal of an external member, the mass portion 15, the electrode 12d of the moving portion 12, the electrically conductive portion 23b of the package 20 and the lid 22 of the package 20 have a ground potential (same potential) as a desired electric potential.

Now, operations of the acceleration detector 1 will be described.

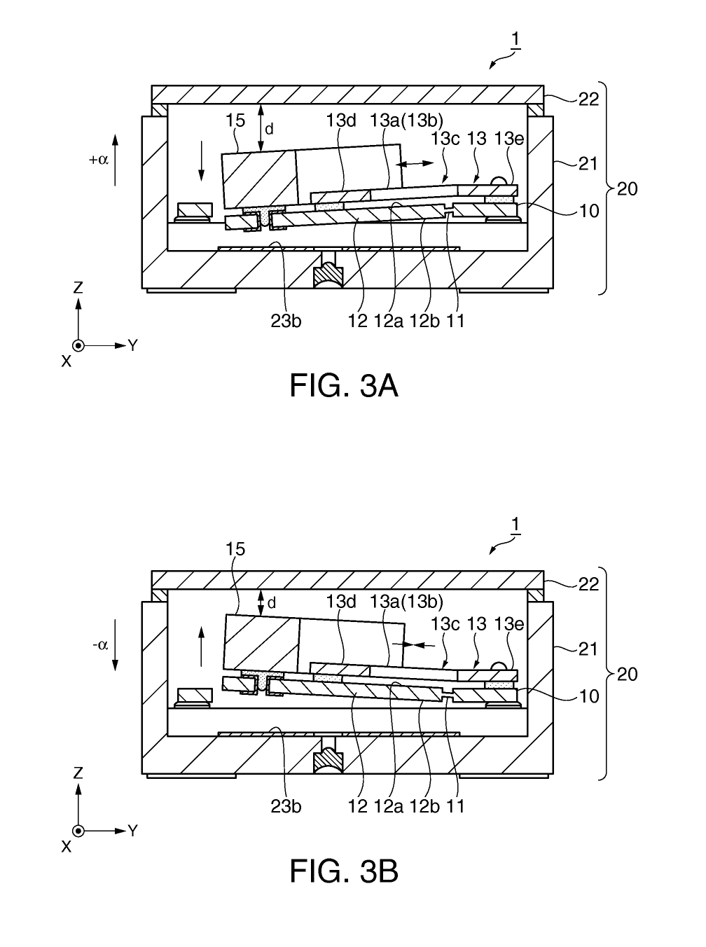

FIGS. 3A and 3B are schematic sectional views illustrating operations of the acceleration detector. FIG. 3A shows the state where the moving part is displaced downward in the drawing (−Z direction). FIG. 3B shows the state where the moving part is displaced upward in the drawing (+Z direction).

In the acceleration detector 1, as shown in FIG. 3A, when the moving part 12 is displaced (flexed) in −Z direction about the joint part 11 as a fulcrum by an inertial force corresponding to acceleration +α applied in Z-axis direction, a tensile force in a direction in which the basal part 13d and the basal part 13e move away from each other in Y-axis direction is applied to the acceleration detection element 13, and tensile stress is generated on the vibration beams 13a, 13b of the acceleration detection portion 13c.

Thus, in the acceleration detector 1, the vibration frequency (hereinafter also referred to as resonance frequency) of the vibration beams 13a, 13b of the acceleration detection portion 13c changes to higher side, for example, like wound-up strings of a string instrument.

Meanwhile, in the acceleration detector 1, as shown in FIG. 3B, when the moving part 12 is displaced in +Z direction about the joint part 11 as a fulcrum by an inertial force corresponding to acceleration −α applied in Z-axis direction, a compressive force in a direction in which the basal part 13d and the basal part 13e approach each other in Y-axis direction is applied to the acceleration detection element 13, and compressive stress is generated on the vibration beams 13a, 13b of the acceleration detection portion 13c.

Thus, in the acceleration detector 1, the resonance frequency of the vibration beams 13a, 13b of the acceleration detection portion 13c changes to lower side, for example, like loosened strings of a string instrument.

The acceleration detector 1 is configured to be able to detect this change in resonance frequency. The acceleration (+α, −α) applied in Z-axis direction is derived by conversion to a numeric value defined by a lookup table or the like according to the rate of the detected change in resonance frequency.

Here, in the acceleration detector 1, as shown in FIGS. 3A and 3B, the distance d between the mass portion 15 and the lid 22 of the package 20 changes according to the acceleration (+α, −α) applied in Z-axis direction.

In the acceleration detector 1, if the mass portion 15 and the lid 22 do not have the same electric potential, electrostatic capacitance is generated between the mass portion 15 and the lid 22. According to the equation (1), this electrostatic capacitance increases and decreases, linked with the change in the distance d (variable capacitance).

By the coupling between the mass portion 15 and the acceleration detection element 13, this increasing and decreasing electrostatic capacitance is added to the oscillation circuit of the acceleration detection element 13 and the vibration of the acceleration detection element 13 may become unstable.

In the acceleration detector 1, the external terminal 28b enables the mass portion 15 and the lid 22 of the package 20 to be maintained at the same electric potential, as described above. As the external terminal 28b is connected to a circuit wiring that is set to a desired electric potential such as ground potential, the mass portion 15, and the lid 22 and the electrically conductive portion 23b of the package 20 can be maintained at the same electric potential. Thus, in the acceleration detector 1, since there is no potential difference between the mass portion 15 and the lid 22, the electrostatic capacitance between the mass portion 15 and the lid 22 is eliminated (is not generated).

Consequently, in the acceleration detector 1, since the electrostatic capacitance is not added to the oscillation circuit of the acceleration detection element 13, the vibration of the acceleration detection element 13 can be maintained in stable state.

The above feature will be described in detail with reference to drawings.

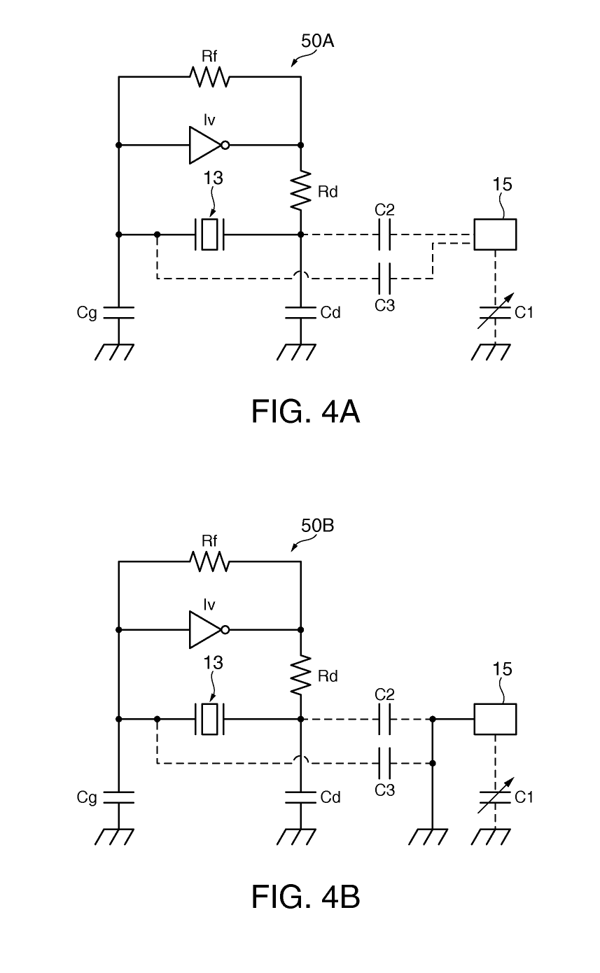

FIGS. 4A and 4B are circuit diagrams of an oscillation circuit including an acceleration detection element. FIG. 4A is a circuit diagram showing the case where the lid 22 is at ground potential and the mass portion and the lid do not have the same electric potential. FIG. 4B is a circuit diagram showing the case where at least one of the lid 22 and the electrically conductive portion 23b has the same electric potential as the mass portion.

As shown in FIGS. 4A and 4B, oscillation circuits 50A, 50B are typical oscillation circuits of a double-ended tuning fork-type vibration element. Each of the oscillation circuits has the acceleration detection element 13, an inverter Iv, a feedback resistance Rf, a drain resistor Rd, gate capacitance Cg and drain capacitance Cd.

With this configuration, the acceleration detection element 13 oscillates at a predetermined resonance frequency (for example, about 32 kHz) in the state where no acceleration is applied.

When the mass portion 15 and the lid 22 do not have the same electric potential (in the case of the related art), as shown in FIG. 4A, electrostatic capacitance C1 that increases and decreases with the vibration of the moving portion 12 between the mass portion 15 and the lid 22 is added to the oscillation circuit 50A, together with parasitic capacitance (floating capacitance, spatial capacity) C2, C3 generated between the wiring 13f and the mass portion 15 or the like and between the wiring 13g and the mass portion 15 or the like. Therefore, the vibration of the acceleration detection element 13 may become unstable (the resonance frequency may increase and decrease).

Meanwhile, when the mass portion 15 is maintained at a desired electric potential, that is, when the mass portion 15 and the lid 22 have the same electric potential (ground potential) (in the case of this embodiment), as shown in FIG. 4B, the line of the parasitic capacitance C2, the line of the parasitic capacitance C3 and the electrostatic capacitance C1 are fixed to a predetermined electric potential. Thus, the risk that noise is transmitted to the oscillation circuit 50B via the parasitic capacitance C2, C3 and the addition of the electrostatic capacitance C1 to the oscillation circuit 50B do not occur (the electrostatic capacitance C1 is eliminated substantially).

Consequently, in the acceleration detector 1, the vibration of the acceleration detection element 13 can be maintained in stable state. The parasitic capacitance C2, C3 is corrected by a change in the gate capacitance Cg and the drain capacitance Cd.

In the acceleration detector 1, if the mass portion 15 is maintained at a desired electric potential (preferably ground potential), irrespective of whether the lid 22, the electrically conductive portion 23b and the mass portion 15 are maintained at the same electric potential or not, it can be expected that the influence of electrical disturbance such as an electric field is made to detour to a desired electric potential (circuit wiring) via the mass portion 15 instead of reaching the wiring where an electrical signal of the acceleration detection element 13 is taken out, thus reducing the influence of the disturbance on electric properties of the acceleration detector 1.

As described above, in the acceleration detector 1 of the first embodiment, the wirings 13f, 13g for taking out the detected acceleration as an electrical signal are provided in the acceleration detection element 13, and the mass portion 15 loaded in the moving portion 12 is maintained at a desired electric potential.

Consequently, in the acceleration detector 1, as the mass portion 15 and the lid 22, which is a part of the package 20, have the same electric potential, the electrostatic capacitance C1 between the mass portion 15 and the lid 22 is eliminated. Therefore, the coupling between the mass portion 15 and the acceleration detection element 13 can be avoided and the vibration of the acceleration detection element 13 can be maintained in stable state.

Thus, acceleration detection properties such as acceleration detection accuracy of the acceleration detector 1 can be improved.

Also, in the acceleration detector 1, the mass portion 15, the electrode 12d provided through the through-hole 12c to the two main surfaces 12a, 12b of the moving portion 12, the lid 22, which is a part of the package 20, and the electrically conductive portion 23b of the package base 21 are electrically connected with each other and therefore have the same electric potential.

Consequently, in the acceleration detector 1, the generation of electric charges with different polarities on the two main surfaces 12a, 12b due to the piezoelectric effect in the bonding part of the moving portion 12 with the mass portion 15 is restrained and the electrostatic force between the moving portion 12 (electrode 12d), and the lid 22 and the electrically conductive portion 23b of the package base 21, can be mostly eliminated. Therefore, the obstruction to the flexure (displacement) of the moving portion 12 by the electrostatic force can be restrained.

Thus, acceleration detection properties such as acceleration detection sensitivity of the acceleration detector 1 can be improved.

Also, in the acceleration detector 1, the mass portion 15 has the substantially U-shaped cur-out part 15a penetrating the mass portion 15 in the direction of thickness (Z-axis direction) and is loaded on the main surface 12a of the moving portion 12 where the acceleration detection element 13 is loaded. A part of the acceleration detection element 13 is arranged within the cut-out part 15a of the mass portion 15, as viewed in a plan view.

Consequently, in the acceleration detector 1, the space of the moving portion 12 can be efficiently utilized and further reduction in size can be realized, while acceleration detection properties can be improved by the above effects and advantages.

Moreover, in the acceleration detector 1, the flexible portion includes the base portion 10 and the moving portion 12 connected to the base portion 10 via the joint part 11, and the moving portion 12 can be displaced in the direction (Z-axis direction) that intersects the main surface 12a (12b) of the moving portion 12 about the joint part 11 as a fulcrum by an inertial force. In the acceleration detector 1, the acceleration detection element 13 is laid across the joint part 11 to the main surface 10a of the base portion 10 and to the main surface 12a of the moving portion 12, and the mass portion 15 is loaded on the main surface 12a of the moving portion 12.

Thus, the flexible portion (moving portion 12) can flex more easily, for example, than in the configuration without the joint part 11. Therefore, particularly detection sensitivity, of acceleration detection properties of the acceleration detector 1, can be further improved.

However, in the acceleration detector 1, even if the mass portion 15 is loaded on the side of the main surface 12b instead of the side of the main surface 12a of the moving portion 12, the mass portion 15, the electrode 12d of the moving portion 12, the lid 22 of the package 20 and the electrically conductive portion 23b of the package 20 are maintained at the same electric potential. Therefore, effects similar to the above can be achieved.

The acceleration detector 1 may configured in such a way that, for example, integrated circuit components are accommodated in the package 20, as a circuit for forming the oscillation circuit 50B with other elements than the acceleration detection element 13.

### Second Embodiment

Next, a clinometer as an electronic apparatus having the acceleration detector as a physical quantity detector described in the first embodiment will be described.

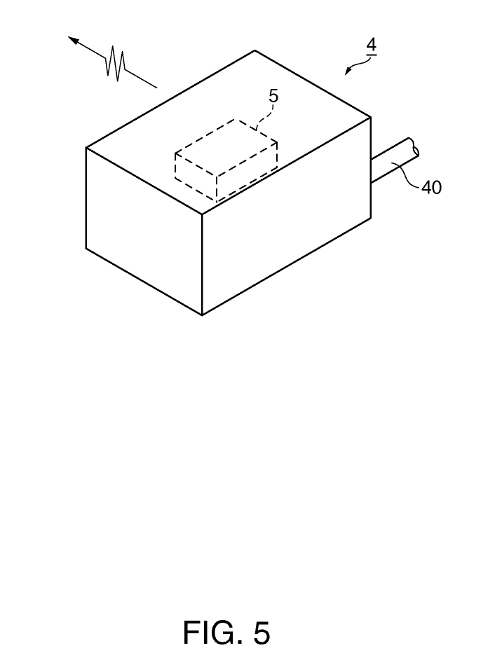

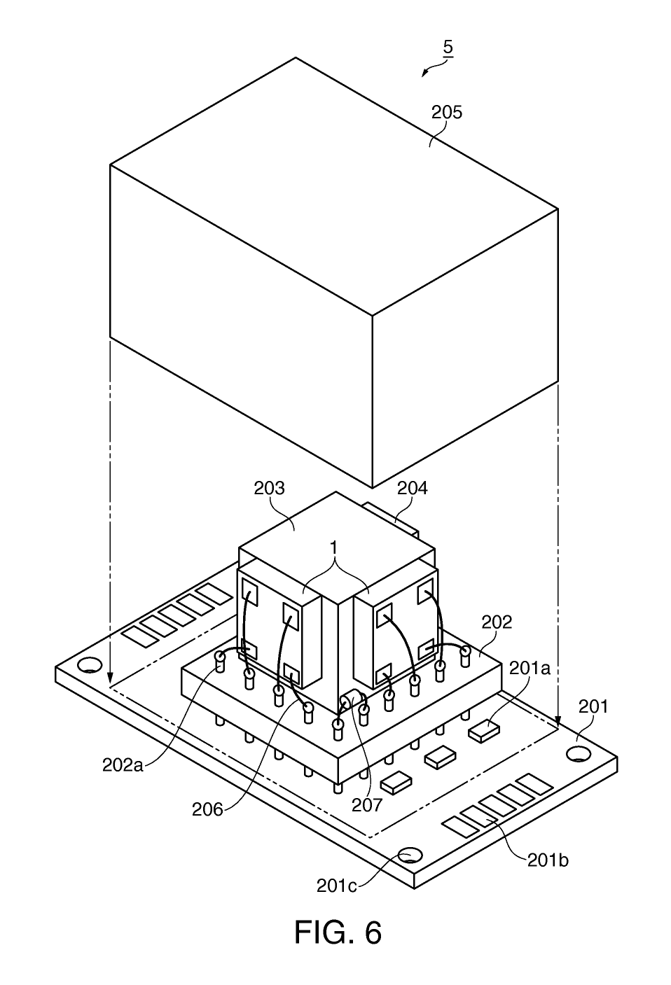

FIG. 5 is a schematic perspective view showing a clinometer according to a second embodiment. FIG. 6 is a partly exploded schematic perspective view showing a schematic configuration of an inclination sensor module accommodated within the clinometer.

As shown in FIGS. 5 and 6, a clinometer 4 includes the acceleration detector 1 described in the first embodiment, as an inclination sensor of an inclination sensor module 5.

As shown in FIG. 6, the inclination sensor module 5 has a base substrate 201, an insulating substrate 202, a base 203, the acceleration detectors 1, an oscillator 204 and a cap 205 and is accommodated within the clinometer 4.

For the rectangular flat plate-like base substrate 201, for example, FR-4 (an epoxy resin substrate with a glass fabric) is used. Circuit elements 201a loaded on the base substrate 201 form a peripheral circuit related to the acceleration detectors 1 and the oscillator 204. Also, a terminal 201b for input to and output from outside (clinometer body) and an attachment hole 201c to the clinometer body are formed on the base substrate 201.

For the rectangular flat plate-like insulating substrate 202, a resin having a low thermal conductivity and high heat resistance, electric properties, dimensional stability and the like such as PBT (polybutyleneterephthalate) or LCP (liquid crystal polymer) is used. The insulating substrate 202 is connected to the base substrate 201 via a spacing by plural thin pin-like (rod-like) connection pins 202a fixed in and penetrating the insulating substrate 202 in the direction of thickness.

The base 203 is formed substantially in a rectangular parallelepiped shape by slicing or sheet metal processing of a metal such as aluminum, aluminum alloy, copper or copper alloy. The base 203 is fixed to the insulating substrate 202, for example, with an adhesive. The above resin, aluminum oxide-based sintered body (ceramics) or the like may also be used for the base 203.

The acceleration detectors 1 and the oscillator 204 are fixed to lateral sides of the base 203 (surfaces standing upright in relation to the insulating substrate 202), for example, with an electrically conductive adhesive. The two acceleration detectors 1 are fixed respectively to lateral sides that are next to each other and connected to each other at right angles, of the base 203. Thus, the inclination sensor module 5 can detect an inclination from two axes that are orthogonal to each other.

The oscillator 204 is fixed to a lateral side opposite to the lateral side of the base 203 where one of the acceleration detectors 1 is fixed (in other words, a lateral side next to the lateral side where the other acceleration detector 1 is fixed).

The acceleration detectors 1 and the oscillator 204 are connected to the connection pins 202a in the insulating substrate 202 by lead wires 206 and are connected to the base substrate 201 via the connection pins 202a.

Near one of the acceleration detectors 1, a thermistor 207 for detecting ambient temperature (temperature sensor) is provided. The thermistor 207 is provided as a temperature detection unit used for detecting ambient temperature and carrying out temperature compensation (temperature correction) of frequency characteristics of the acceleration detectors 1 and the oscillator 204.

The thermistor 207 is, similarly to the acceleration detectors 1 and the oscillator 204, connected to the connection pins 202a in the insulating substrate 202 by lead wires 206 and is connected to the base substrate 201 via the connection pins 202a.

The oscillator 204 is provided as a reference frequency (reference resonance frequency) oscillating source of a comparator circuit which compares the reference frequency with the resonance frequency of the acceleration detector 1 when acceleration is detected.

For the box-shaped cap 205 having an opening to the side of the base substrate 201, a resin with a low thermal conductivity (PBT, ABS, PC or the like) is used, similarly to the insulating substrate 202. The cap 205 is fixed to the base substrate 201 in such a way as to cover the insulating substrate 202, the base 203, the acceleration detectors 1, the thermistor 207, the oscillator 204, the circuit elements 201a and the like on the base substrate 201.

With these configurations, the inclination sensor module 5 can delay the arrival of an ambient temperature change at the acceleration detectors 1. More specifically, thermal conduction in contact with the base substrate 201 is delayed by the thin pin-like connection pins 202a and the insulating substrate 202 using the resin with a low thermal conductivity. Thermal conduction due to convection of ambient air around the acceleration detectors 1 and radiating heat (radiant heat) from external members is delayed as the cap 205 using the resin with a low thermal conductivity shuts off the outside air and radiation heat sources.

In the inclination sensor module 5, as the arrival of an ambient temperature change at the acceleration detectors 1 is delayed in this manner, gradual temperature change in the acceleration detectors 1 is enabled. Therefore, good acceleration detection properties, for example, acceleration detection accuracy or the like, of the acceleration detector 1 can be maintained.

Back to FIG. 5, the clinometer 4 is installed in a place to be measured, for example, on a mountain slope, a road slope face, a retaining wall surface of a raised ground level or the like. The clinometer 4 is supplied with power from outside via a cable 40 or has a built-in power supply. A drive signal is sent to the inclination sensor module 5 (acceleration detectors 1) from a drive circuit, not shown.

In the clinometer 4, a detection circuit, not shown, detects a change in the attitude of the clinometer 4 (a change in the direction in which gravitational acceleration is applied to the clinometer 4) based on the frequency difference of each of the resonance frequency that changes according to gravitational acceleration applied to the inclination sensor modules (acceleration detectors 1), then converts the detected change into angle, and transfers the data thereof to a base station, for example via wireless communication or the cable 40. Thus, the clinometer 4 can contribute to daily management or early detection of abnormality.

The above acceleration detector 1 is not limited to the clinometer and can be suitably used as an acceleration sensor, inclination sensor or the like of a seismometer, navigation device, attitude control device, game controller, mobile phone and the like. In any of these cases, an electronic apparatus having the effects and advantages described in the embodiments can be provided.

In the embodiment, the material of the base portion 10, the joint part 11 and the moving portion 12 is not limited to quartz crystal and may be glass or a semiconductor material such as silicon.

The material of the acceleration detection element 13 is not limited to quartz crystal and may be a piezoelectric material such as lithium tantalate (LiTaO₃), lithium tetraborate (Li₂B₄O₇), lithium niobate (LiNbO₃), lead zirconate titanate (PZT), zinc oxide (ZnO) or aluminum nitride (AlN), or a semiconductor material such as silicon having a coating of a piezoelectric material such as zinc oxide (ZnO) or aluminum nitride (AlN).

The invention is described above using an acceleration detector as an example of a physical quantity detector. However, the invention is not limited to this example and can also be applied to physical quantity detectors for detecting a force, velocity, distance or the like from results of acceleration detection.

The entire disclosure of Japanese Patent Application No. 2011-186959, filed Aug. 30, 2011 is expressly incorporated by reference herein.

What is claimed is:

1. A physical quantity detector comprising:
a plate-like flexible portion having piezoelectricity;
a physical quantity detection element loaded at least on one of two main surfaces of the flexible portion;
an electrically conductive mass portion loaded on the flexible portion; and
a package accommodating the flexible portion, the physical quantity detection element and the mass portion;
wherein the physical quantity detection element is provided with a wiring through which a detected physical quantity is taken out as an electrical signal, and the mass portion can be maintained at a desired electric potential.

2. The physical quantity detector according to claim 1, wherein the package includes a package base in which the flexible portion, the physical quantity detection element and the mass portion are loaded, and
an electrically conductive cover which is loaded on the package base and covers the physical quantity detection element, and
the mass portion can be maintained at the same electric potential as the cover.

3. The physical quantity detector according to claim 2, wherein, in the package base, an electrically conductive portion is provided on an inner bottom surface that is opposite to the cover,
the flexible portion has an electrode provided extending to the two main surfaces, and
the mass portion is electrically connected to the electrode and can be maintained at the same electric potential as the electrically conductive portion.

4. The physical quantity detector according to claim 1, wherein the mass portion has a cut-out part and is loaded on the main surface of the flexible portion where the physical quantity detection element is loaded, and
a part of the physical quantity detection element is arranged within the cut-out part of the mass portion, as viewed in a plan view.

5. The physical quantity detector according to claim 1, wherein the flexible portion has a base portion and a moving portion connected to the base portion via a joint part,
the moving portion can be displaced in a direction that intersects a main surface of the moving portion, about the joint part as a fulcrum,
the physical quantity detection element is laid across the joint part to the base portion and the moving portion, and
the mass portion is loaded on the main surface of the moving portion.

6. An electronic apparatus comprising the physical quantity detector according to claim 1.

7. An electronic apparatus comprising the physical quantity detector according to claim 2.

8. An electronic apparatus comprising the physical quantity detector according to claim 3.
